(19) United States
(12) Patent Application Publication
(10) Pub. No.: US 2024/0286939 A1
(43) Pub. Date: Aug. 29, 2024

(54) ADVANCED GRANULAR SLUDGE BED REACTOR

(71) Applicant: Aquatech International LLC, Canonsburg, PA (US)

(72) Inventors: Ravi Chidambaran, Canonsburg, PA (US); Nitin Chandan, Pune (IN); Narendra Singh Bisht, Pune (IN); Vishal Vishwas Phalke, Pune (IN)

(21) Appl. No.: 18/583,350

(22) Filed: Feb. 21, 2024

(30) Foreign Application Priority Data
Feb. 21, 2023 (IN) 202311011731

(51) Int. Cl. C02F 3/30; C02F 3/00; C02F 101/10

(52) U.S. Cl. CPC C02F 3/301; C02F 3/308; C02F 2003/003; C02F 2101/105; C02F 2209/06; C02F 2209/18; C02F 2209/22

(57) ABSTRACT

An enhanced granular sludge bed (AGBR) process for wastewater treatment, including use of fluidized bed media and process control by regulating redox reaction conditions, is provided. Further embodiments may relate to multiple stage biological processes with fluidized bed media for simultaneous removal of carbon and nutrient from wastewater.

### CROSS-REFERENCE TO RELATED APPLICATIONS

This application claims priority to Indian patent application Ser. No. 202311011731, filed on Feb. 21, 2023. The entirety of that application is incorporated by reference herein.

### BACKGROUND OF THE INVENTION

### Field of Invention

Embodiments relate to reactor processes for wastewater treatment.

### Background of the Related Art

Activated sludge processes (ASP) have achieved a wide range of acceptability for removal of biodegradable organic compounds from wastewater. ASP is easy to operate and control within given set of operational conditions. Despite many advantages, ASP has a number of limitations, typically including but not limited to the following:
1. ASP works in an oxidative environment, which requires a continuous supply of air.
2. ASP works in single oxidation-reduction potential (ORP) regime, which oxidizes all biological elements like carbon and nitrogen.
3. ASP requires a separate de-nitrification step for further removal of total nitrogen from the system.
4. ASP forms flocculated sludge, which needs separation through membrane or clarifier.
5. Footprint requirement for ASP is substantial, because for each elemental conversion by oxidation/reduction separate reactors will be needed.
6. Energy consumption for ASP is high due to continuous air supply.

Based on a traditional activated sludge process, further variations of activated sludge process have been developed. Nowadays, a Sequencing Batch Reactor (SBR) process is more prevalent for the application of automatic control technology in industry. SBR processes have become a research hotspot in the field of sewage treatment. The SBR is one of the integrated systems for anaerobic-aerobic bioreactors in which the wastewater is treated in a fill and draw method.

The SBR process typically comprises five steps, which include filling, reacting, settling, decanting and rest. The SBR process, as an enhanced form of the conventional treatment systems, presents flexibility for the treatment of variant influents, the lowest operator interaction, an alternative for aerobic and anaerobic environments in the same chamber, an excellent oxygen interaction with microorganism and substrate, a lesser footprint, superior removal efficiency and the requirement of less energy input. These benefits validate the increased interest in the adoption of the SBR process for the treatment of both municipal and industrial wastewater.

Although the operation of SBR process and effluent treatment has gained momentum, still there is room for significant improvement. Anaerobic and aerobic cycle times in the SBR system may generate some issues regarding controlling the anaerobic-aerobic microbial groups and therefore, selection and enhancement of the biomass became necessary. Regulation of the anoxic and aerobic phase during the SBR process can enrich the targeted microbial population, and hence, improve the process efficiency. The duration of the phase, dissolved oxygen concentration, and mixing conditions can be changed in accordance with the particular requirement of the treatment plant². Position of specific microbial culture in sludge is extremely important during SBR operation. The activities of particular culture in certain regime of oxidative environment play an important role in removal of pollutants from wastewater. Reaction conditions are crucial parameters for stepwise removal of pollutants from wastewater, as shown in FIG. 1.

### BRIEF SUMMARY OF THE INVENTION

We provide an enhanced advanced granular sludge bed reactor (AGBR) process for wastewater treatment, including use of fluidized bed media and process control by regulating redox reaction conditions. Further embodiments may relate to multiple stage biological processes with fluidized bed media for simultaneous removal of carbon and nutrient from wastewater.

Embodiments may, but are not required to, satisfy one or more of the following objectives.
1. To further advance the SBR process with control of parameters to improve sludge character.
2. To use finely divided media in an SBR process for microbial protection and improve the sludge character.
3. To improve overall nutrient removal in SBR process and substantially increase capacity for ammonia removal by a factor of 1.5-3 times.
4. To form mechanically robust sludge particles to absorb shock loads during different SBR steps.
5. To use “feast and famine” conditions for simultaneous removal of contaminants from the wastewater.
6. To define and control operational parameters within a narrow range based on real time analytical data monitoring and trigger the sequential steps based on achievement of operational values as against time based logic to go from one step to the next step. This reduces the energy consumption by 30-40%.

With multiple reactions happening in the SBR reactor, protection of various cultures has previously been a tedious task in a mixed culture reactor. Therefore, there is a need to regulate an SBR process in such a manner that one can control various redox reactions within its boundary limits and not allow parameters to shift from certain ranges. It is possible to achieve the process control with the help of parameters, like DO, pH, ORP and real time analytical data collection. Also, there is necessity to provide protection to various microbial cultures so that it will find certain place to take shelter, grow and continue to perform according to the need of reactor redox conditions to remove specific pollutant from the influent.

In embodiments as reported herein, finely divided media is being used in SBR process. The media acts as a seed or nuclei to help formation and further grow size of the biomass particle, keeping it bonded with the help of EPS (Extra polymeric substances).

Laboratory trials were conducted with a single reactor, which was operated in SBR mode by controlling the air usage. The reactor of 1200 mm height was used for the study. The reactor was filled with biological reaction mixture leaving 100 mm as free board space.

Various sensors including pH, DO, ORP were submerged in the reactor to monitor real time data, including redox conditions within the reactor. The Real time data was linked with analytical data, which was monitored at each stage of SBR. Based on real time data of pH, ORP, DO and analytical data like COD, ammonia nitrogen, nitrate and phosphate, the reaction kinetics were defined. The reactor was operated in a fully automated mode for each step of operation without much manual intervention. The reactor was provided with a fine bubble air diffuser and feed distributor at the bottom. The SBR process was operated in different steps; like feed, rest, aeration, settling and decanting.

The feed water was added to thick sludge bed in an upward direction. Addition of feed was done at low velocity so that it can establish good contact with microbial sludge bed. At this stage ORP of the reactor was in the range of −50 to −300 mV, more specifically between −150 to −250 mV. The condition of deficient dissolved oxygen was maintained for 30 min to 300 min depending on feed water characteristics. After holding low oxygen environment, gradual increase of dissolved oxygen was started with supply of air containing oxygen. The DO level of the reactor was increased 1.0 to 6.5 mg/lit and more specifically between 3.0 to 5.5 mg/lit. This was the peak of oxidative environment in the reactor and after this peak, oxygen was cut off and gradual drop of DO started to attain DO<0.1 mg/lit.

During aeration and non-aeration phases multiple reactions take place within the reactor like oxidation of carbon and nitrogen and denitrification etc. Media used in the SBR process plays an important role to accomplish various reactions. The porous media provides core space for accumulation of de-nitrifying bacteria so that it does not come in contact with aerobic environment. Simultaneously the outer surface of media holds aerobic culture which is needed for carbon and nitrogen oxidation. The high porosity of media provides clear path for nitrogen oxides to reach the de-nitrifying bacteria sitting at the inner most part of the media. The core part of the media also holds phosphorous accumulating bacteria, which are responsible for reduction in phosphate in feed water.

The media applied in the process could be powder activated carbon, granular activated carbon, sand or walnut shell media or any other media having the ability to fluidize and the necessary porosity; also, it should sustain the biological condition of the reactor. The size of media used is approximately 50 to 500 micron but it can range from 50 to 200 micron. The size of media plays an important role to define sludge characteristics and settling velocity of sludge. Overall results show that there was improved reduction of carbon along with nutrients; in the SBR process operated with finely divided porous media. Sludge settling was very fast and treated water removed was 40 to 75% of the reactor volume. The biological activation of media in an advanced granular sludge bed reactor (AGBR) process is shown in FIG. 2.

Having operated an SBR reactor with and without media, we have observed that reactor with media indicated better performance over without media. The use of media plays a crucial role in binding different biological culture around its surface and providing pockets to accommodate the anoxic/anaerobic bacteria inside and remain protected from the external oxygen supply.

FIG. 3 shows optimum operational conditions achieved during SBR operation with and without media. In a single-stage SBR reactor both aerobic and non-aerobic condition remain operative. A reactor without media shows that best results in terms of carbon and nitrogen reduction up to 30% exchange volume. Further increments in exchange volume affected ammonia nitrogen and total nitrogen reduction. This could be due to presence of insufficient bacterial culture to carry forward the reaction at higher exchange volume. Also, there was no resistance for oxygen entry till core of the media; this affected the activity of de-nitrifying bacteria which helps to remove total nitrogen from the system.

When media was used in the reactor, the media provided protection for the bacteria present at the core of the sludge particle, and oxygen entry became limited. As per the results obtained, walnut media shows better oxygen resistance as compared to Powdered activated carbon (PAC) media, which resulted in growth of de-nitrifying bacteria. This was confirmed by bacterial count analysis.

With PAC media, the optimum condition was at 40% exchange volume, which shows >90% ammonia and >80% total nitrogen reduction. However, with walnut shell media because of better growth of aerobic, nitrifying and de-nitrifying bacteria, overall nitrogen reduction was improved. Ammonia reduction was 99% and total nitrogen reduction was >90%. Also, the reactor with walnut media showed an optimum condition at 45-50% exchange volume, which was 33% more than the SBR reactor without media. Therefore, we observed that application of media not only provided the conducive environment for growth and protection of different bio-culture but also a conducive environment for control of the process parameters by providing resistance to oxygen entry at the core of media. This helps to maintain the aerobic, anoxic and anaerobic condition at the localized sludge particle as per the need. This combination successfully removes maximum carbon and nitrogen from the wastewater.

In exemplary embodiments, a batch reactor process for purification of wastewater, comprises, in a single vessel: feeding and distributing a wastewater into a microbial sludge bed; keeping the wastewater in an environment including anaerobic bacteria until reaching a target pH; increasing an amount of oxygen in the wastewater in an aeration step, and keeping the wastewater in an oxygenated environment including aerobic bacteria; allowing the sludge bed to settle, thereby separating the microbial sludge bed from the purified wastewater; and removing a volume of purified wastewater.

In some embodiments, the process further comprises, after removing the volume of purified wastewater, returning to the step of feeding wastewater through the microbial sludge bed.

In some embodiments, the process further comprises maintaining the aerobic bacteria, anoxic and anaerobic bacteria in culture on fluidized bed media.

In some embodiments, the media is selected from the group consisting of walnut shell, powder activated carbon, granular activated carbon, and sand.

In some embodiments, the media is walnut shell.

In some embodiments, the walnut shell media has a particle size between 50 to 500 micron, preferably 50 to 200 micron.

In some embodiments, the media is present in the vessel at 2 to 25% of reactor volume, preferably between 5 to 12% of reactor volume.

In some embodiments, the media has a mesh size between 50 to 500.

In some embodiments, the media is floated with the aeration step and homogenized with biological sludge in the settling step.

In some embodiments, the aerobic and anaerobic bacteria are supported on the culture medium.

In some embodiments, the process further comprises analyzing one or more parameters selected from the group consisting of biological oxygen demand, chemical oxygen demand, dissolved oxygen, nitrogen concentration, and nitrate concentration, and advancing the process to a subsequent step when a threshold value for a parameter is met.

In some embodiments, analysis is continuous during operation of the batch reactor process.

In some embodiments, the analysis leads to full automation of the batch reactor process.

In some embodiments, more than 90% of carbon and 90% of nitrogen are removed from the wastewater by the purification.

In some embodiments, the purification removes phosphate from the wastewater.

Other details, objects, and advantages of the deployable waveguide and methods of making and using the same will become apparent as the following description of certain exemplary embodiments thereof proceeds.

### BRIEF DESCRIPTION OF THE FIGURES

The above and other objects, aspects, features, advantages and possible applications of the present innovation will be more apparent from the following more particular description thereof, presented in conjunction with the following drawings. Like reference numbers used in the drawings may identify like components.

FIG. 1 shows biological reactions in a typical sequencing batch reactor process.

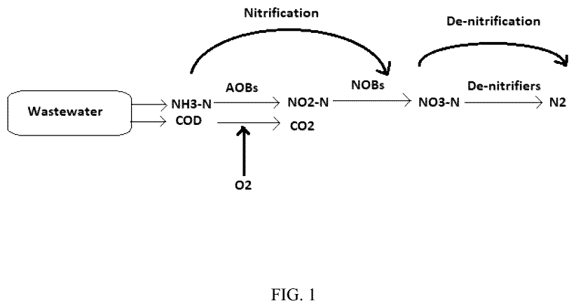

FIG. 2 shows biological activation of media in an advanced granular sludge bed reactor process as reported herein.

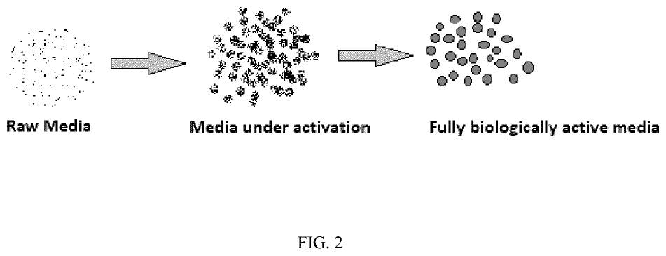

FIG. 3 shows operation of an advanced granular sludge bed reaction in different conditions.

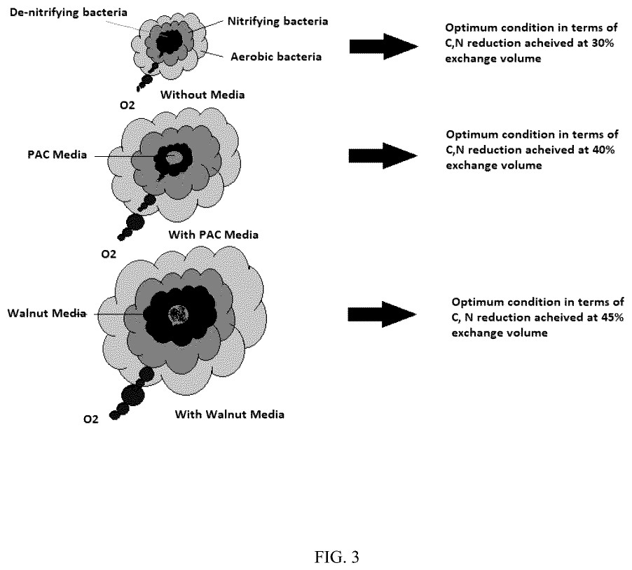

FIG. 4 shows a flow scheme of a reactor operation according to an embodiment as reported herein.

FIG. 5 shows SVI and Prod. TSS of an SBR reactor

FIG. 6 shows a trend of COD reduction with change in reactor HRT.

FIG. 7 shows ammonia nitrogen reduction in an SBR reactor.

FIG. 8 shows total nitrogen reduction in an SBR reactor.

FIG. 9 shows trends of COD reduction during AGBR operation with PAC media.

FIG. 10A shows ammoniacal nitrogen reduction with PAC-AGBR.

FIG. 10B shows total nitrogen reduction with PAC-AGBR.

FIG. 11 shows trends of ammonia nitrogen, nitrate, and DO during cyclic operation.

FIG. 12 shows pH and ORP trends during cyclic operation of an AGBR process.

FIG. 13 shows COD reduction in an AGBR process.

FIG. 14 shows a trend of ammonia nitrogen reduction in AGBR with walnut media.

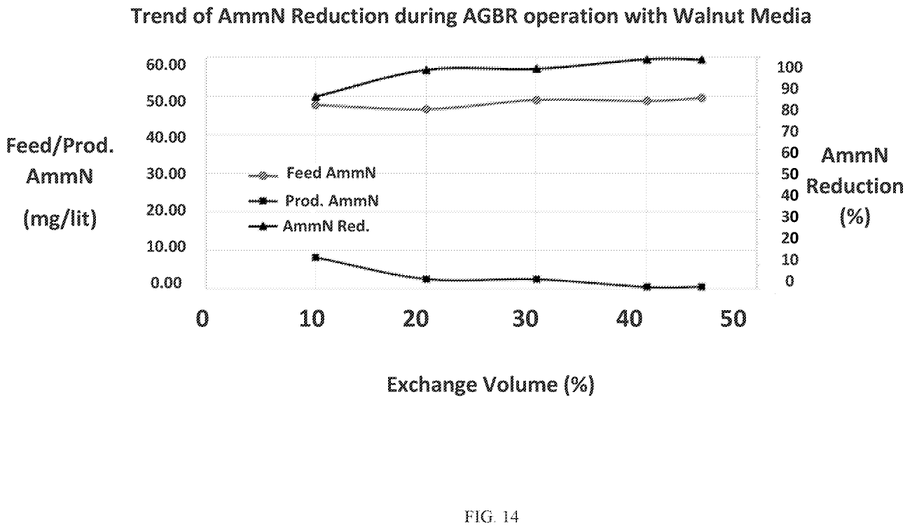

FIG. 15 shows a trend of TN reduction during AGBR operation with walnut media.

FIG. 16 shows a trend of product turbidity reduction over time.

FIG. 17A shows a trend of ammonia nitrogen reduction.

FIG. 17B shows a trend of total nitrogen.

FIG. 17C shows a trend of phosphate removal in SBR and AGBR processes.

FIG. 18A shows an AGBR process control with real time data.

FIG. 18B shows AGBR process control with real time data.

FIG. 19 shows an image of dry sludge.

FIG. 20 shows an image of dry sludge after crushing.

FIG. 21A shows an SEM image of media before AGBR operation.

FIG. 21B shows an SEM image of media after AGBR operation.

FIG. 22 shows an SEM image of outer surface of media after biological activation.

FIG. 23A shows a porous structure of media before AGBR operation.

FIG. 23B shows a porous structure of media after AGBR operation.

FIG. 24A shows an SEM image of raw walnut media.

FIG. 24B shows an SEM image of activated walnut media.

FIG. 25A shows an SEM image of internal morphology of raw walnut media.

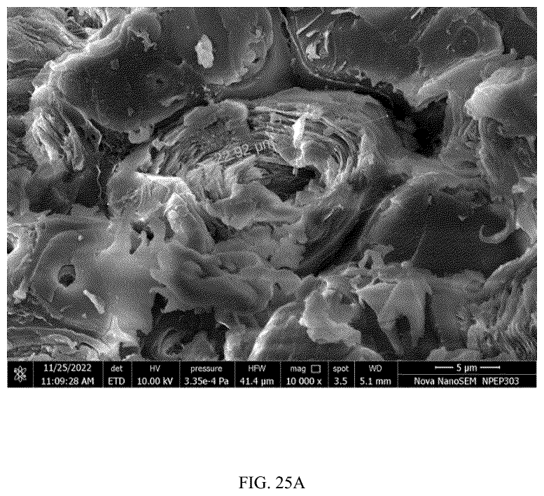

FIG. 25B shows an SEM image of internal morphology of activated walnut media.

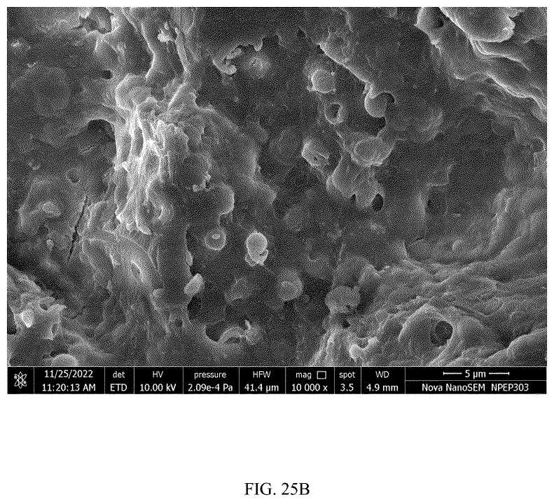

### DETAILED DESCRIPTION OF THE PRESENT INVENTION

The following description is of exemplary embodiments and methods of use that are presently contemplated for carrying out the present invention. This description is not to be taken in a limiting sense, but is made merely for the purpose of describing the general principles and features of various aspects of the present invention. The scope of the present invention is not limited by this description.

### SBR Operational Flow Scheme

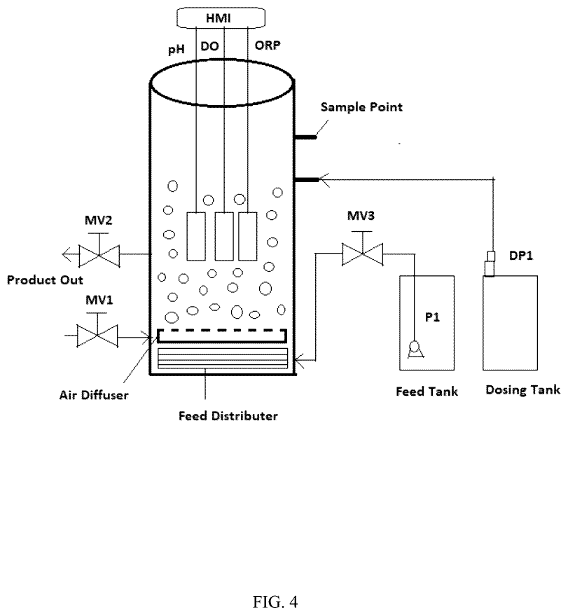

Embodiments of the present application, as reported more fully herein in the context of the trials reported below, provide a single stage reactor having a flow scheme as shown in FIG. 4. As shown in the figure, the feed water enters to the SBR reactor through pump P1 from bottom side. A distribution channel was provided at the bottom of the reactor for delivery of feed water along periphery of the reactor and proper contact with thick sludge bed. The feeding was associated with step of rest to attain pH in desired range before start of aeration.

In the next step air was supplied to the SBR reactor through valve MV1, from bottom side. The air supplied makes homogeneous mixture and takes forward the biological reactions. The aeration step was followed by step of sludge settling. The air was stopped after a period of contact, and sludge was allowed to settle. Typical sludge settling time is between 5 to 60 minutes. The biomass settled down at the bottom and occupied about 25 to 50% of the reactor volume with the remaining volume including treated product water.

The product water, which was free of total suspended solids (TSS) was decanted from the reactor from valve MV2 in such a manner that level of reactor from all sides dropped down equally. Further, decanted volume of product water was replaced by addition of feed water to continue the cyclic operation.

Initially the reactor was operated without addition of any media to understand the process performance. Some embodiments as reported herein would encompass such media-free operation. In other embodiments, as tested in subsequent experiments, different types of media were tried to achieve optimum process and operational parameters. During each experiment, initially the reactor was operated at high hydraulic retention time (HRT) by keeping low exchange volume which was gradually increased to reduce HRT in steps. Simulated wastewater having mixtures of carbon, nitrogen and phosphorous was used as feed for all the experimental study. During the study, operational and process parameters were monitored to draw hypothesis of reaction kinetics and role of media in SBR operation. The reactor operation was monitored and controlled in different redox conditions on the basis of real time data.

### Experiment 1 SBR Reactor Operation without Media

Initially biological SBR process was studied without addition of any media in the reactor. The start-up was done by using activated sludge collected from the municipal sewage treatment facility. The steps followed while start-up of the SBR process without any media addition are shown below.
1. The SBR reactor was filled up to 25 to 30% with fresh sludge collected from a sewer treatment plant (STP) facility.
2. After sludge addition, simulated feed water was slowly added to the reactor from bottom side. The water contained carbon, nitrogen and phosphate. The feed water character is given in Table 1.
3. The reactor was filled to its capacity with feed water, and sequential operation having steps of fill, aeration, settling and withdrawal was started.
4. Initially the exchange volume was kept at 10%; after getting stable results of ammonia and COD, the exchange volume was increased to next level. In this way it was increased up to 40 to 50% in five steps.
5. The process parameters like pH, DO, ORP, ammonia nitrogen and nitrate were monitored digitally by collecting real time of each sequential step, right from feed to withdrawal.
6. Samples were also collected for offline analyses of parameters like chemical oxygen demand (COD), biological oxygen demand (BOD), Alkalinity, Turbidity and TSS.

TABLE 1
Characterization of feed water

| Parameter | Unit | Value (mg/lit) |
|---|---|---|
| COD | mg/lit | 806 |
| BOD | mg/lit | 450 |
| Ammonia Nitrogen | mg/lit | 48.6 |
| Nitrate | mg/lit | 0.56 |
| Nitrite | mg/lit | 0.03 |
| Total Nitrogen | mg/lit | 49.19 |
| Phosphate | mg/lit | 9.15 |

As stated above this experiment was carried out without addition of any media to the reactor. The operational conditions were maintained to follow steps in sequence. Feed water having character as per Table 1 was fed to the reactor, exchange volume was increased from 10% to 45% in 40 days of operation. The effect of increase of exchange volume and decrease of reactor HRT were studied. Numerous observations and parameter wise data analysis is given below.

### SVI and Product TSS of the SBR Reactor:

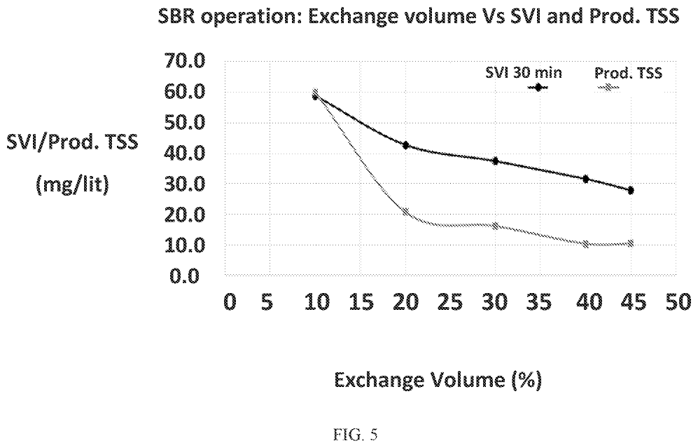

We observed that the SBR reactor got stabilized with stepwise increase of exchange volume. Initially sludge settling was poor and sludge volume index (SVI30) was high. With time, as the system adopts to operational conditions, SVI30 of the reactor reduced and this change was reflected in product TSS which was gradually reduced to <10 mg/lit, even at increased exchange volume. This shows that the sequence of operation followed was well suited for the sludge granulation and improved its settling property. As shown in FIG. 5, during increase of exchange volume from 10 to 45% there was decrease in SVI30 from 59 to 28 and product TSS was reduced from 60 mg/lit to 10 mg/lit. This shows that sequencing time and air flow were well matched for the SBR operation.

The pH and ORP of the SBR reactor during sequential operation are tabulated in Table 2.

TABLE 2
pH and ORP of SBR reactor

| | | ORP |
|---|---|---|
| Operational Sequence | pH | mV |
| Feed + Anaerobic | 6.81 | −136 |
| Aeration | 6.97 | 87 |
| Settling | 6.91 | 55 |
| Withdrawal | 6.90 | 46 |

As shown in Table 2, change in operational condition is reflected in change in value of pH and ORP. During feed+anaerobic condition the ORP of the reactor went in a negative direction, while with aeration step ORP of the reactor increased to a positive direction. The shift of ORP and pH with operational condition indicates the response of microbial culture towards change in environmental condition and activate the microbial activity to reduce organic pollutants present in wastewater. In the absence of oxygen when wastewater comes in contact with thick sludge bed during flow from bottom to top, anaerobic conditions created at the innermost part of sludge particle start the breakdown of high molecular weight organic compound into low molecular weight acid. This is reflected in a drop of pH during the step of feed+anaerobic treatment.

### COD and BOD Reduction in SBR:

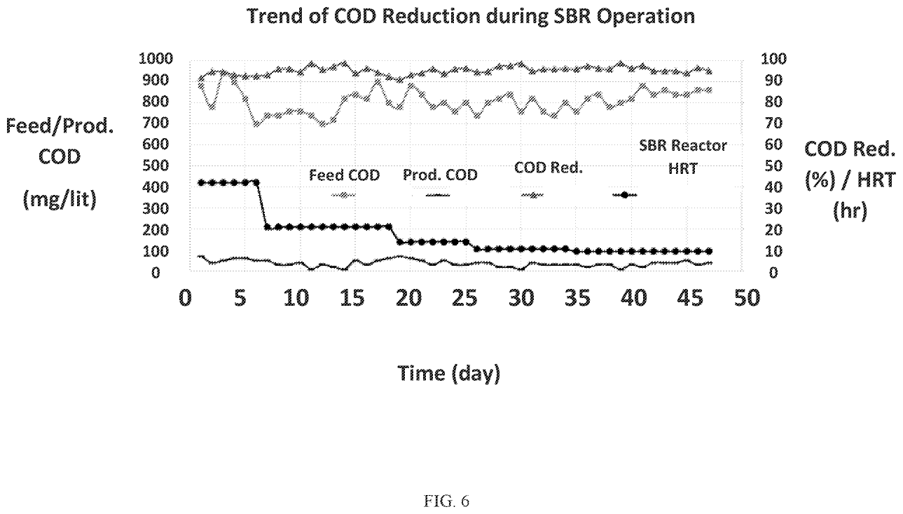

Throughout the experiment, SBR reactors showed consistent COD and BOD removal. Reduction of reactor HRT from 42 to 9.3 hr had no effect on carbon removal, and COD reduction was consistently maintained at >90%. The trend of COD reduction with respect to change in HRT is shown in FIG. 6 while BOD results are given in Table 3.

TABLE 3
Results of BOD reduction during SBR operation

| Feed BOD | Prod. BOD | % Reduction |
|---|---|---|
| 560.00 | 37.00 | 93.39 |
| 464.10 | 25.33 | 94.54 |
| 487.20 | 20.22 | 95.84 |
| 551.25 | 16.38 | 97.02 |
| 487.20 | 26.52 | 94.55 |

### Reduction of Ammonia Nitrogen and Total Nitrogen in SBR

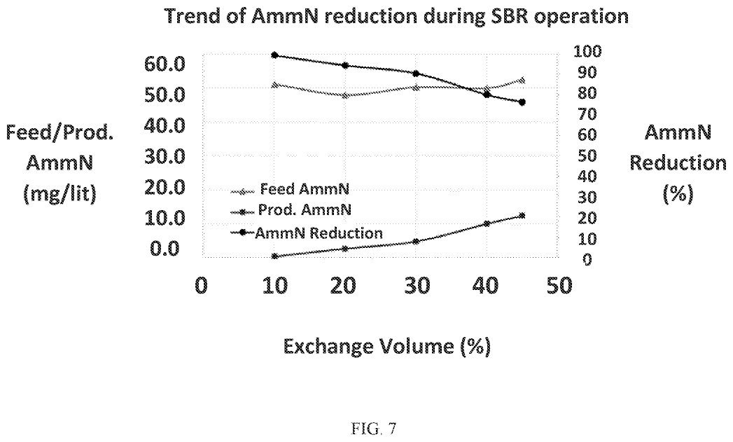

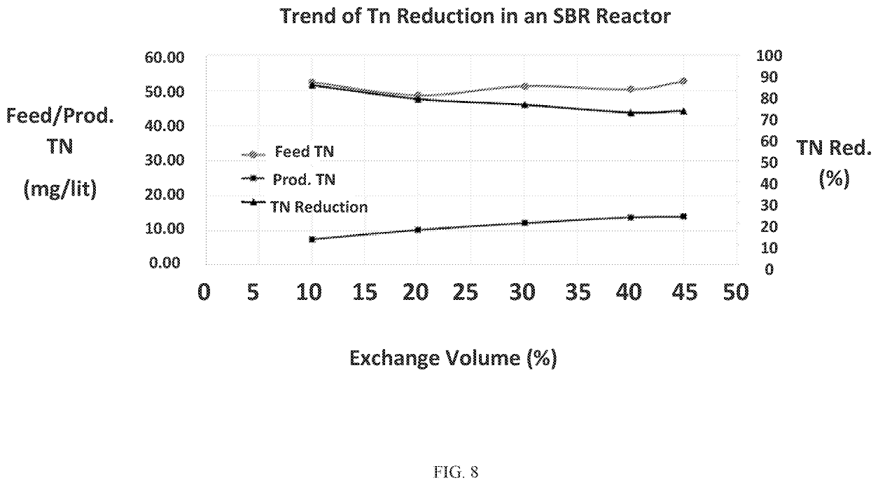

Trends of ammonia nitrogen and total nitrogen (TN) reduction are shown in FIG. 7 and FIG. 8 respectively. The nitrogen reduction is plotted against increase in exchange volume to understand its effect over the reactor performance. We observed that until 30% exchange volume, ammonia nitrogen in product was <5.0 ppm but with increase of exchange volume to 40% and 45%, the product ammonia nitrogen was increased to 10 and 12 ppm respectively. Increase in ammonia nitrogen in product was observed to be impacting total nitrogen reduction as well.

It was seen that total nitrogen reduction was dropped from 86% to 74% with increase of exchange volume from 10% to 45%. Nitrate value in product was in the range of 6 to 7 ppm till 30% exchange volume but with increase of exchange volume at 45% product nitrate value was reduced to 1.23 ppm. This could be due poor reduction of ammonia nitrogen at high exchange volume and availability less nitrogen oxide in the reactor for further de-nitrification. Overall Data of nitrogen obtained with different exchange volume is tabulated in Table 4a and Table 4b.

TABLE 4a

| | | | |
|---|---|---|---|
| Exchange | | Ammoniacal | Nitrate |
| volume | HRT | Nitrogen (ppm) | (ppm) |

| % | hr | Feed | Prod. | Red. | Feed | Prod. |
|---|---|---|---|---|---|---|
| 10 | 42.0 | 51.10 | 0.37 | 99.28 | 1.13 | 6.57 |
| 20 | 21.0 | 47.90 | 2.71 | 94.34 | 0.67 | 7.05 |
| 30 | 14.0 | 50.20 | 4.80 | 90.44 | 1.04 | 6.39 |
| 40 | 10.5 | 49.93 | 10.01 | 79.95 | 0.34 | 1.98 |
| 45 | 9.3 | 52.45 | 12.36 | 76.43 | 0.15 | 1.23 |

TABLE 4b

| | | |
|---|---|---|
| Exchange | Nitrite | TN |
| volume | (ppm) | (ppm) |

| % | Feed | Prod. | Feed | Prod. | Red. |
|---|---|---|---|---|---|
| 10 | 0.14 | 0.46 | 52.37 | 7.40 | 85.87 |
| 20 | 0.03 | 0.31 | 48.60 | 10.07 | 79.28 |
| 30 | 0.03 | 0.84 | 51.27 | 12.03 | 76.54 |
| 40 | 0.03 | 1.68 | 50.30 | 13.67 | 72.82 |
| 45 | 0.06 | 0.28 | 52.66 | 13.87 | 73.66 |

### Experiment 2 AGBR Reactor Operation with Media

As observed in Experiment 1 (SBR reactor operation without media) it was perceived that the reactor was performing well in terms of sludge settling and COD removal even with high exchange volume. However, with respect to nitrogen removal up to 30% exchange volume there was >90% ammonia nitrogen reduction but increase in exchange volume affected the ammonia reduction. In terms of total nitrogen reduction also increase of exchange volume impacted the reduction.

Therefore overall, it looks that although reactor was showing good carbon reduction, but nitrogen did not remain consistent with change of operating conditions. To remove total nitrogen from the reactor both nitrifying and de-nitrifying bacteria play important role. Different conditions in terms of DO and ORP have to be maintained to sustain bacterial culture in a single reactor process. With simply suspended sludge process keeping those condition intact, is quite difficult. Therefor embodiments of the present application exhibiting the AGBR process has been developed with addition of media in the SBR reactor. Media plays very crucial role in balancing different biological conditions within reactor, acting as catalyst to promote particular biological/chemical reaction(s) as conditions within the reactor dictate and act as nuclei to develop various biological cultures around the media.

### Experiment 2a: Trial with PAC Media

One of the media used in AGBR reactor was powder activated carbon (PAC). The AGBR reactor was operated as shown in flow scheme of FIG. 4. The media was added to the reactor and operation was done as per stages followed in trial of SBR without any media. Feed water composition was used as earlier. The media addition to reactor was range from 100 ppm to 5000 ppm and more specifically in between 1000 to 2000 ppm.

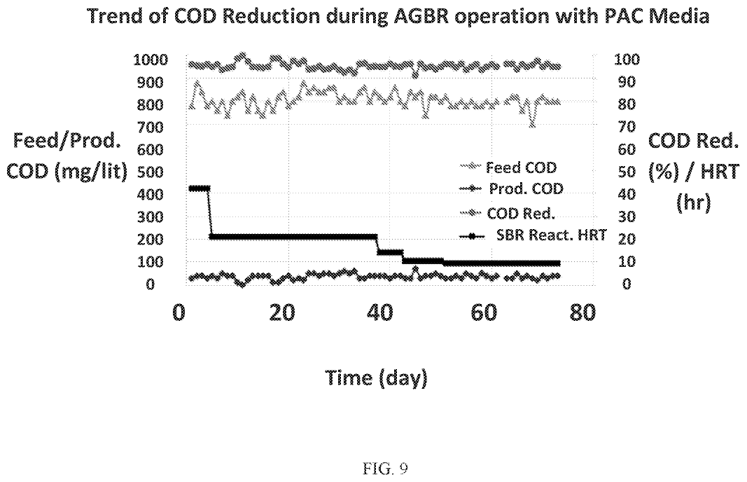

After addition of PAC, the reactor was allowed to get mixed well within the reactor. The samples were collected for monitoring COD, BOD, ammonia nitrogen, nitrate and nitrite. Operational parameters like pH, DO and ORP were monitored online sensors. During AGBR operation with PAC media COD reduction was observed to be very much consistent, all the time it was maintained at >90%. COD reduction from 42 hour to 9.3 HRT is shown in FIG. 9.

Reduction of ammonia and total nitrogen at different exchange volumes is shown in Table 5a and Table 5b during AGBR operation with PAC media.

TABLE 5a

| | | | |
|---|---|---|---|
| | | Ammonia | Nitrite |
| Exchange | HRT | Nitrogen (ppm) | (ppm) |

| volume | Hr | Feed | Prod. | Red. | Feed | Prod. |
|---|---|---|---|---|---|---|
| 10 | 42.0 | 50.70 | 19.29 | 61.95 | 1.09 | 4.97 |
| 20 | 21.0 | 51.00 | 20.60 | 59.61 | 0.27 | 5.51 |
| 30 | 14.0 | 49.60 | 2.57 | 94.82 | 0.45 | 7.20 |
| 40 | 10.5 | 48.10 | 1.82 | 96.22 | 0.39 | 3.46 |
| 45 | 9.3 | 50.50 | 3.35 | 93.37 | 0.56 | 4.11 |

TABLE 5b

| | | | |
|---|---|---|---|
| | | Nitrite | TN |
| Exchange | HRT | (ppm) | (ppm) |

| volume | Hr | Feed | Prod. | Feed | Prod. | Red. |
|---|---|---|---|---|---|---|
| 10 | 42.0 | 0.02 | 0.40 | 51.81 | 24.66 | 52.40 |
| 20 | 21.0 | 0.04 | 0.75 | 51.31 | 26.86 | 47.65 |
| 30 | 14.0 | 0.03 | 3.81 | 50.08 | 13.58 | 72.88 |
| 40 | 10.5 | 0.04 | 3.73 | 48.53 | 9.01 | 81.43 |
| 45 | 9.3 | 0.02 | 7.18 | 51.08 | 14.64 | 71.34 |

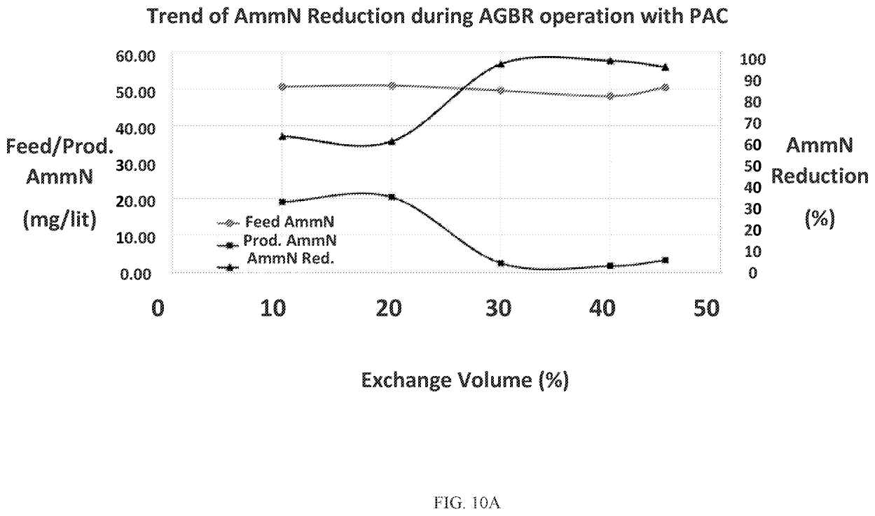

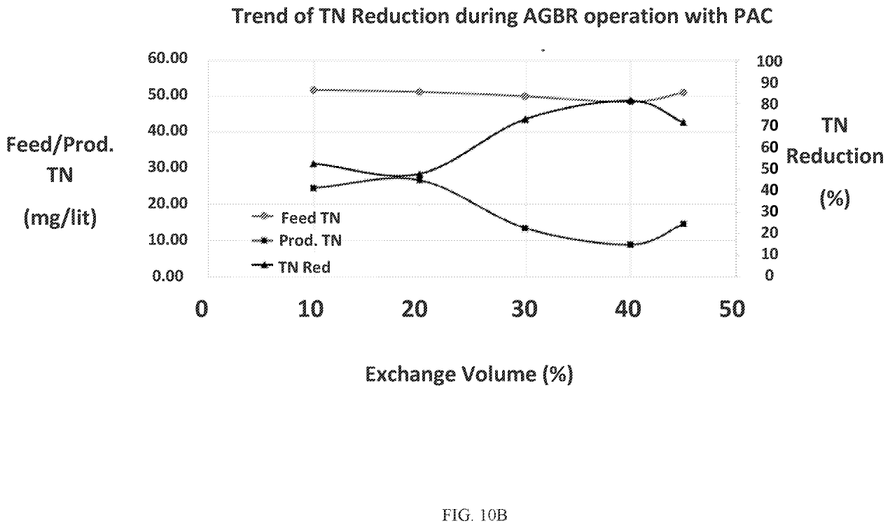

Graphs plotted with exchange volume against ammonia and total nitrogen are shown in FIG. 10A and FIG. 10B.

As per data received during AGBR operation with PAC media, we observed that there was improvement in ammonia nitrogen reduction when exchange volume was increased from 10 to 45%. At 10% exchange volume the ammonia reduction was 61.95% which increased to 93.37%. At 40% exchange volume maximum ammonia reduction (96.22%) was seen. The gradual improvement in ammonia nitrogen reduction can be related with adoption of microbial culture with changed environment having media. Total nitrogen reduction also observed to be improved from 52.40 to 71.34% with increase in exchange volume 10 to 45%. Again, optimum condition of 40% exchange volume shows highest total nitrogen (TN) reduction of 81.43%.

Overall, it can be seen that addition of PAC media is helping to stabilize the ammonia nitrogen reduction even at high exchange volume. The best reduction of ammonia and total nitrogen reduction was observed at 40% exchange volume. As seen in Experiment-1, there was a drop in ammonia nitrogen reduction with increase in exchange volume, but experiments with media showed consistent reduction of ammonia nitrogen which in turn also helped to maintain TN reduction, even when reactor was in operation at high exchange volume and low HRT. The experiment with PAC media gave inspiration to experiment with further trials with another media, therefore the next experiment was done with walnut shell media.

### Experiment 2b: Trial with Walnut Shell Media

Another media used in AGBR process was walnut shell. The AGBR reactor was commissioned by addition of walnut shell media along with suspended sludge. The flow scheme and operation philosophy were kept same as earlier experiment. (FIG. 4) The main objective was to observe the effect of walnut shell media addition to the performance of AGBR reactor over earlier experiments. The walnut media added to the reactor was 2 to 25% of the reactor volume and more specifically between 5 to 12%.

The size of media used also played an important role during AGBR operation. The size of media used in the range of 20 to 200 mesh and more specifically in between 40 to 100 mesh. Also, it is important that media should remain in fluidized condition during aeration and settle down along with sludge during settling period. There should not be any distinct separation that takes place between media and sludge; both should remain and behave in homogeneous condition during operation of AGBR.

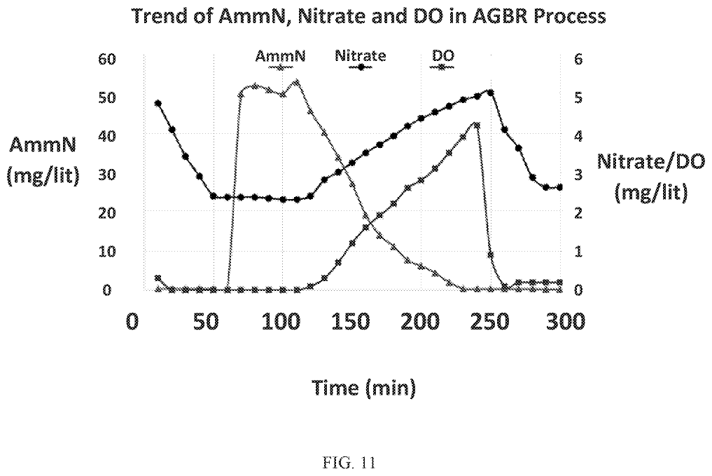

As per earlier experiments the reactor commissioning was done from 10 to 50% exchange volume. The process parameters and analytical parameters monitoring was done at each stage of the process. The ammonia nitrogen and nitrate were continually analyzed with online sensors and its correlation with operational parameters like DO, pH and ORP was established. Other parameters like COD, BOD, TSS, Turbidity and alkalinity were monitored as per standard analytical methods. FIG. 11 shows trends of reduction of ammonia nitrogen and nitrate during cycling operation of AGBR process.

Average values of DO, ORP and pH during each stage of cyclic operation of AGBR process is given in Table 6.

TABLE 6
Cyclic operation control parameters

| | Reactor | Reactor | Reactor |
|---|---|---|---|
| | pH | ORP | DO |
| Phase | — | mV | mg/lit |
| Filling + Anaerobic | 7.25 | −133 | 0.05 |
| Aerobic | 7.66 | +100 | 4.05 |
| Settling | 7.68 | +68 | 0.50 |
| Withdrawal | 7.65 | +18 | 0.20 |

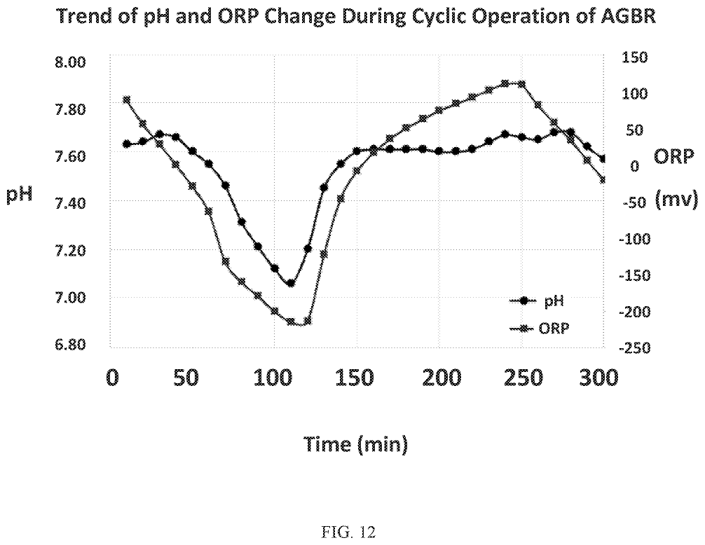

Referring to FIG. 11, FIG. 12, and Table 6 data, it can be observed that there is shift of parameters like pH, DO and ORP during cyclic operation of AGBR process. The first step was feed+anaerobic in which feed water entered from bottom of the reactor into thick sludge bed. During this step ORP of the reactor was gradually reduced up to −200 to −250 and more specifically between −100 to −200 mV.

In the absence of oxygen, as indicated by DO of 0.05 mg/lit, the anaerobic reaction got promoted. There was a gradual decrease of ORP during the step of feed+anaerobic. The promotion of anaerobic reaction can also be indicated by drop in pH during this step. Drop in pH shows that the biodegradable components in wastewater get break down into smaller molecular weight fatty acids. The first stage lasts for 30 to 200 min and more specifically between 60 to 100 min, depending upon the change in process parameters pH, DO and ORP with reference to constituents present in wastewater.

As shown in FIG. 11, the ammonia nitrogen concentration in the reactor reached to the maximum level during first step of AGBR process. In the next step of AGBR process aeration got started from bottom of the reactor to mix the sludge homogeneously. At this stage different reactions took place in the reactor simultaneously. The step of aeration lasts for 30 min to 150 min and more specifically between 60 min to 100 min. During the aeration step the DO of AGBR reactor gradually increased from 0.05 to >4.0 mg/lit. The increase of DO was reflected in increase in ORP value, ORP increased to >100 mV. During aeration step removal carbon and ammonia nitrogen takes place in the AGBR reactor. The ammonia nitrogen was observed to be gradually reduced to <1.0 ppm, due to presence of carbon, nitrogen, and air at the same time in the reactor; simultaneous removal of carbon and nitrogen took place in the reactor.

The use of media supports creation of a layer of different biological conditions around the media's surface. The outermost layer consists of an aerobic condition which promotes nitrification while the innermost contains anaerobic condition which aids to promote de-nitrification. Therefore, it can be said that simultaneous nitrification and de-nitrification taking place in the AGBR reactor, to remove all carbon and nitrogen in a single stage AGBR reactor.

During the aerobic stage, it was observed that some excess nitrate remained in the reactor. That excess nitrate was consumed during the settling phase when DO/ORP started to reduce gradually. The settling stage is the third stage in AGBR process, during this stage the sludge and water got separated. The sludge settled down at the bottom, and supernatant treated water was removed from the reactor. During this settling stage the DO and ORP of the reactor were reduced, and this condition helped to remove minor nitrate and nitrite that remained unreacted during aeration stage.

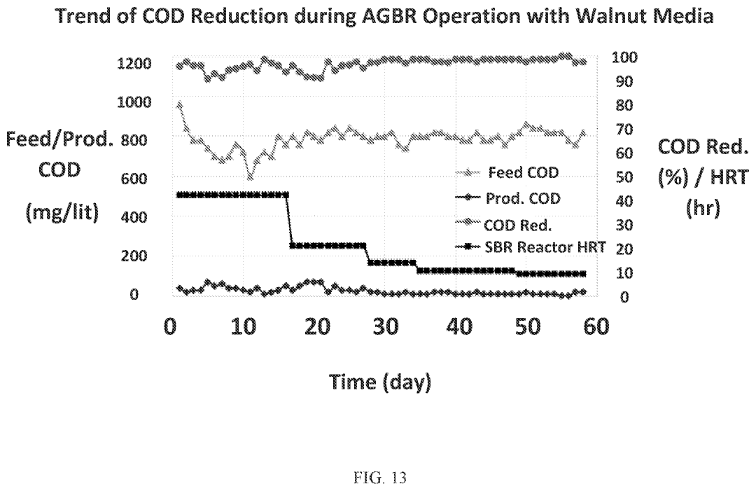

Finally, the stage of withdrawal comes, during which specific volume of water removed from the reactor and the reactor get ready to treat next batch of fresh feed water. Trend of COD reduction with decrease of HRT from 42 hours to 9.3 hours is shown in FIG. 13.

It was observed to be very much stable with decrease of HRT from 42 to 9.3 hours. Same trend was followed with BOD reduction as well, Table 7 shows reduction of BOD during walnut AGBR trial. The BOD reduction was observed to be much improved as compared to trials done without media. A <5.0 ppm BOD was achieved with walnut media AGBR reactor.

TABLE 7
BOD reduction during walnut-AGBR trial

| Exchange volume | Feed BOD | Prod. BOD | Reduction (%) |
|---|---|---|---|
| 10 | 503 | 22.00 | 95.6 |
| 20 | 505 | 15.00 | 97.0 |
| 30 | 462 | 6.13 | 98.7 |
| 40 | 467 | 5.00 | 98.9 |
| 45 | 480 | 4.66 | 99.0 |

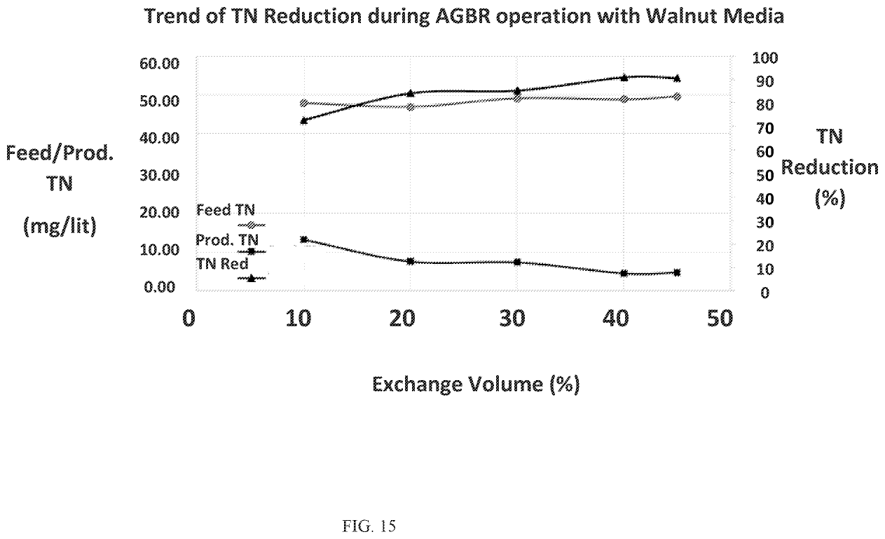

The data for reduction of ammonia nitrogen and total nitrogen with increase in exchange volume from 10 to 45% is shown in Table 8 and FIG. 15.

TABLE 8a
Data of Ammonia nitrogen and Total nitrogen
reduction in AGBR with Walnut media

| | | Ammonia | | | Nitrate | | Nitrite | |
|---|---|---|---|---|---|---|---|---|
| Exchange | HRT | Nitrogen (ppm) | | | (ppm) | | (ppm) | |
| volume | hr | Feed | Prod. | Red. | Feed | Prod. | Feed | Prod. |
| 10 | 42.00 | 47.69 | 8.05 | 83.12 | 0.21 | 5.02 | 0.02 | 0.06 |
| 20 | 21.00 | 46.58 | 2.46 | 94.72 | 0.32 | 4.97 | 0.03 | 0.10 |
| 30 | 14.00 | 49.00 | 2.39 | 95.12 | 0.11 | 2.97 | 0.01 | 1.97 |
| 40 | 10.50 | 48.70 | 0.36 | 99.26 | 0.06 | 2.68 | 0.08 | 1.48 |
| 45 | 9.30 | 49.50 | 0.42 | 99.15 | 0.08 | 2.38 | 0.02 | 1.93 |

TABLE 8b
Data of Ammonia nitrogen and Total nitrogen
reduction in AGBR with Walnut media

| | | |
|---|---|---|
| Exchange | HRT | Total Nitrogen |

| volume | hr | Feed | Prod. | Red. |
|---|---|---|---|---|
| 10 | 42.00 | 47.92 | 13.13 | 72.60 |
| 20 | 21.00 | 46.93 | 7.53 | 83.95 |
| 30 | 14.00 | 49.12 | 7.33 | 85.08 |
| 40 | 10.50 | 48.84 | 4.52 | 90.75 |
| 45 | 9.30 | 49.60 | 4.73 | 90.46 |

The AGBR reactor with walnut media shows improved reduction of ammonia and total nitrogen reduction even at high exchange volume. 99% ammonia nitrogen reduction and >90% total nitrogen reduction were achieved. This can be correlated with response of use of natural media in the biological process which became homogeneous with the environment and biomass and provided satisfactory condition for growth of different bio-culture.

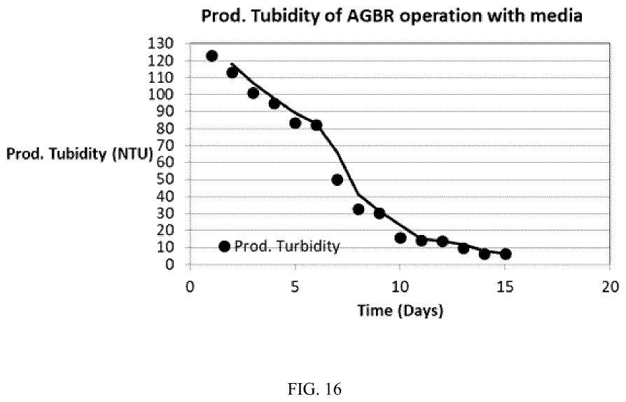

As sludge is having very good settling property, the product turbidity was observed reduced to <10 NTU in AGBR media reactor. The product turbidity was observed to be achieved to <10 NTU within 15 days of start-up as shown in FIG. 16.

Trial with High Ammonia Nitrogen Feed:

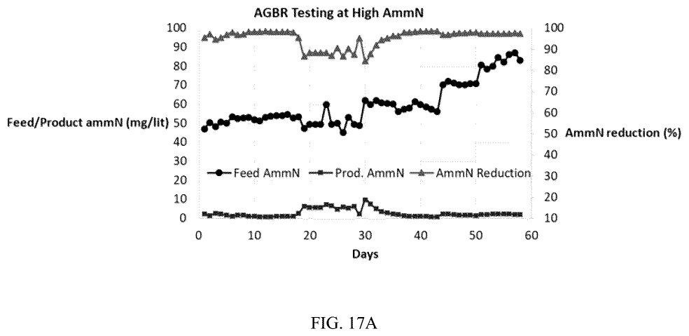

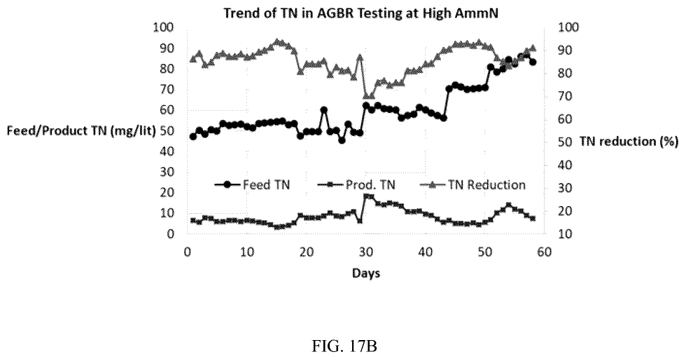

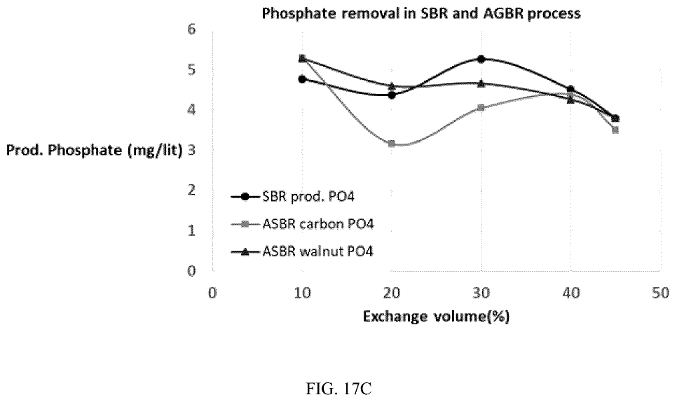

After stabilizing the reactor at a desired feed condition, the ammonia concentration in feed water was increased gradually by keeping other feed constituents the same. The feed ammonia nitrogen concentration was increased from 50 to 80 mg/lit. The trend of both ammonia nitrogen and total nitrogen during the study is shown in FIG. 17A and FIG. 17B

It was observed that even at high ammonia nitrogen concentration feed; there was >90% reduction in ammonia nitrogen and >80% reduction in total nitrogen through AGBR process.

### Phosphate Removal:

For phosphate removal, in all three experiments trend of phosphate removal was observed to be almost in similar range. All the trials showed <4 ppm phosphate at the final outlet at 45% exchange volume. Trend of phosphate with change in exchange volume is shown in FIG. 17C.

### Process Control on the Basis of Analytical Parameters:

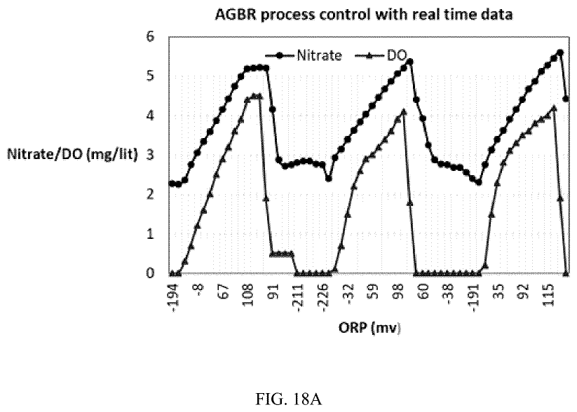

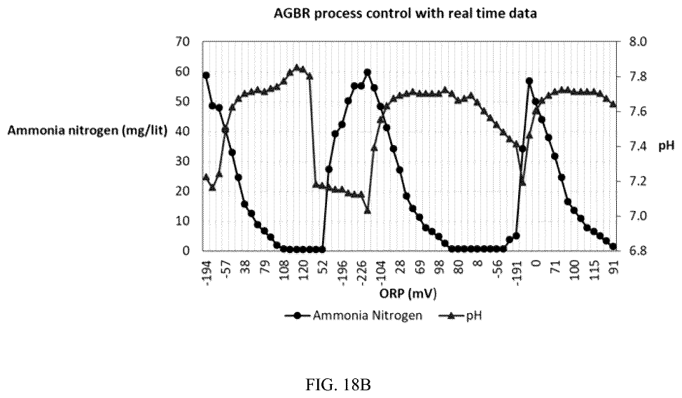

In embodiments the AGBR reactor is provided with various online sensors to monitors the process parameters during cyclic operation. In a particular trial, the process was controlled based on analytical parameters like DO, ORP, pH, ammonia nitrogen and nitrate. Inclination of the analytical parameters as per change in reactor condition is shown in FIG. 18A and FIG. 18B.

The operational philosophy of the AGBR process was set on the basis of analytical parameters. As shown in FIG. 18A and FIG. 18B, the change in ORP is the indicator of conversion of ammonia nitrogen from one state to another. The ORP range of −200 to −150 mV signifies anaerobic conditions at which feed ammonia nitrogen concentration reached to its maximum level. At the same time drop in pH can be observed which shows initiation of degradation of organic compounds in anaerobic condition. After attaining reactor ORP at −200 mV, the anaerobic cycle stopped and aeration started.

During the aeration step the ORP and DO of the reactor keep on increasing. When ORP of the reactor attained +100 mV and DO at 4.5 mg/lit indicated completion of the aerobic stage. At this point ammonia nitrogen reduced to <1.0 mg/lit and nitrate reach to its peak point of >5.0 mg/lit. This indicates completion of aerobic step and air supply stops at this time.

At the end of aerobic stage correlation of the analytical and operational parameters can be observed in the form of positive ORP, high DO condition, minimum ammonia nitrogen, increase in pH and residual nitrogen oxides. After this the settling get started, during settling the ORP of the reactor dropped down and reached up to 50 mV; simultaneously nitrogen oxide was reduced to <3.0 mg/lit. This is the sign of total nitrogen removal from the reactor; the step withdrawal step then started. Therefore, by monitoring the analytical parameters, one could control cyclic operation of the reactor. This helped to optimize the overall operation of the AGBR reactor and avoid any excess time or air consumption during cyclic operation of the AGBR process.

### Sludge Generation and Sludge Character:

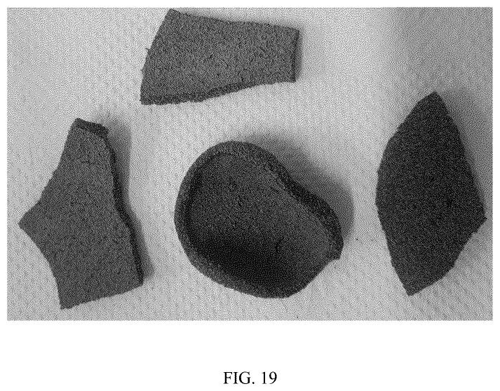

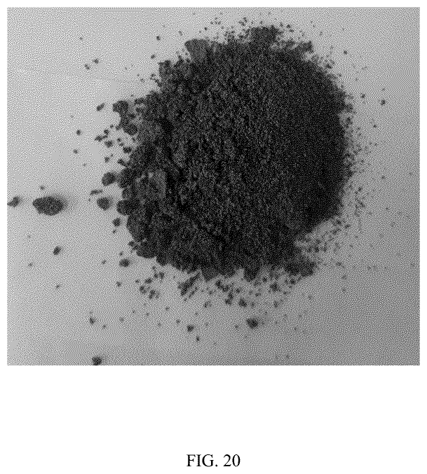

Sludge produced for the AGBR reactor was observed to be much lesser in volume as compared to an activated sludge process. In one trial the AGBR reactor was operated at 100 days SRT and observed to be producing 0.06 Kg sludge/Kg COD. Less sludge generation in the AGBR process can be explained by presence of “feast and famine” conditions in the AGBR reactor. The famine condition promotes bacterial cells to consume biomass, which results in lower sludge generation. As microbial culture adhered to the media, the sludge particles do not stick to each other, remain highly fluidized during aeration, and settle easily while non-aeration condition in the reactor. Sludge produced from walnut AGBR process had very good settling properties. It was very easy to handle sludge in dried form as solid is having free flowing character. FIG. 19 and FIG. 20 shows images of solids produced after drying the AGBR sludge.

### Role of Media

Different types of media were tried in the AGBR reactor to increase its efficiency. The media used in not limited to mixed activated carbon, walnut shell, and PVA gel media. The size of media used in AGBR reactor is ranged from 30 micron to 500 micron and more specifically between 50 microns to 100 microns.

Without wishing to be bound by theory, we believe role of media can be explained as follows. The media used in the reactor act as nuclei and kept sludge particles bonded with each other. Moreover, the media also makes available a porous structure for an anaerobic and de-nitrifying culture to remain stable and protected during a high aerobic environment. Also, the media provides a backbone for microbiological mass and offers mechanical stability. The microbial culture will not easily get washed out from the system as heavy sludge formed in the SBR process along with media.

Presence of media also helps to produce consistent product quality due to high rate of settling. The evidence of media activation in the AGBR reactor was established with the help Scanning Electron Microscope (SEM) and bacteriological analysis. The data was collected during AGBR reactor operation with PAC and Walnut shell media.

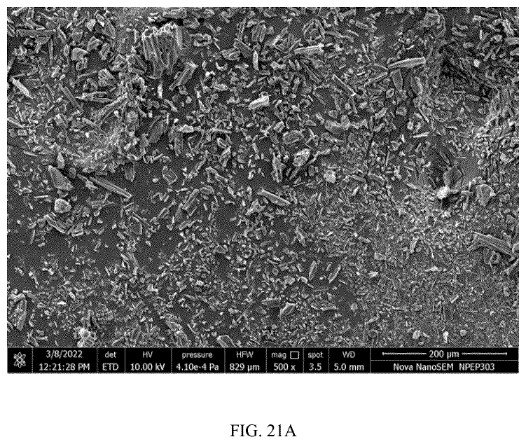

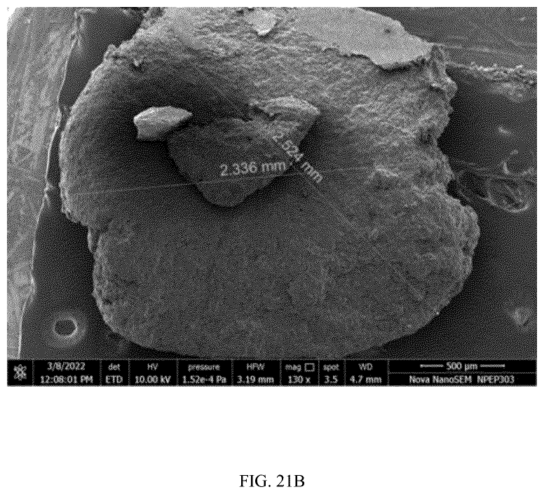

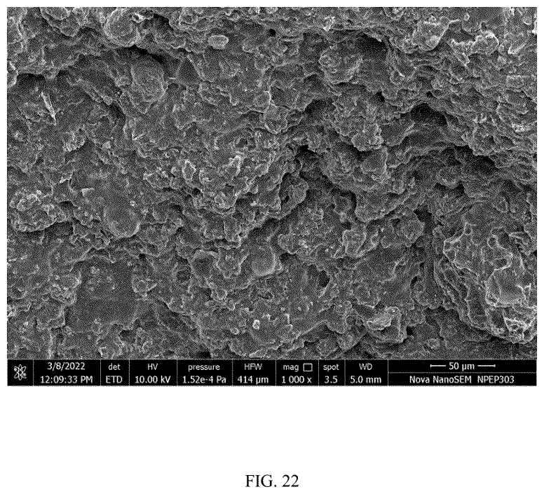

After studying the SBR process along with media for certain time period, we studied the media using a scanning electron microscope (SEM). SEM images of media, before and after exposure to biological conditions, is shown in FIG. 21A and FIG. 21B. The media was observed to be covered with biological culture. As the outer surface is exposed to aerobic condition, certainly aerobic bacteria is likely present at the outermost layer of the media. The deposited microbial culture at the outer surface can be easily seen at higher magnification as shown in SEM image, FIG. 22.

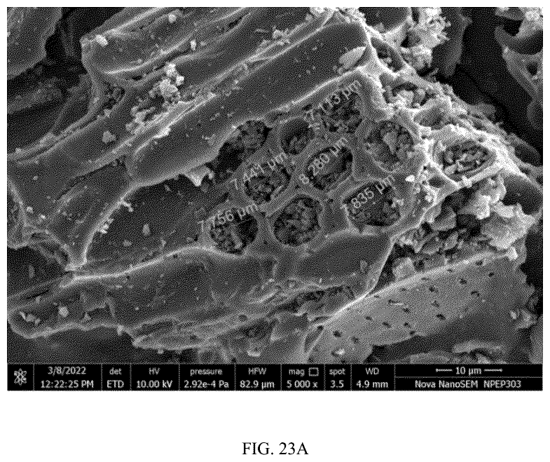

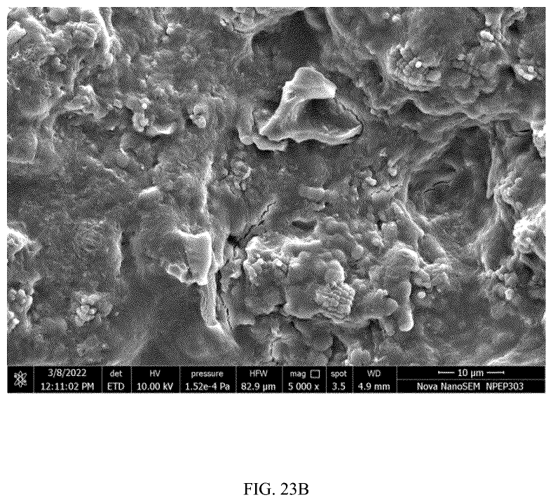

Further, the inner porous part of the media was observed to have accumulated a possible bacterial culture like anaerobic/de-nitrifying bacteria, which were safely residing in the porous structure. FIG. 23A and FIG. 23B show SEM images of porous structure of media before and after SBR operation taken at same magnification.

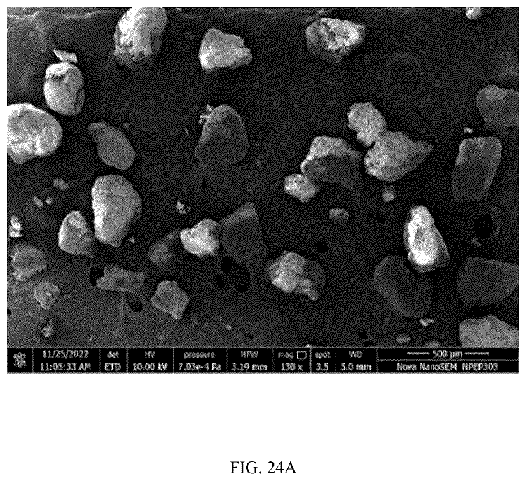

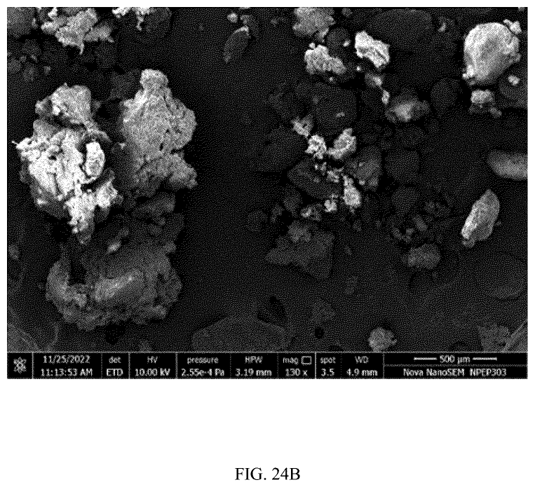

The SEM taken with walnut shell media showed some different morphology as compared to PAC media. The raw walnut media showed uniform size and was oval in shape, whereas PAC media was observed to be highly varied in size and having an elongated shape just like a stick. The internal structure of walnut media observed to be layered, rather than porous as in the case of PAC media. Moreover, walnut media has naturally formed structure which is having better affinity towards biological growth. The open layered structure of media was covered with biological culture when operated in AGBR reactor; the change in outer shape of media indicates development of bio-culture over its surface. The favorability for supporting biological culture was also confirmed by change in internal morphology after activation. The SEM image of raw and biologically activated walnut media is shown in FIG. 24A and FIG. 24B.

As shown in FIG. 23A and FIG. 23B, the layered internal structure of media got totally deposited with biological culture. Culture deposition in a layered structure shows high biological activity over culture deposited in porous structure of PAC media. The bacteriological analysis of sample with PAC and walnut media confirms the evidence. Bacteriological analysis of sludge sample

TABLE 9
Comparison of bacteriological activity
of both PAC and walnut media.

| Sr. | | | Value | |
|---|---|---|---|---|
| No | Parameter | Unit | PAC Media | Walnut Media |
| 1 | Total Aerobic Count | CFU/ml | 1.5 × 10⁹ | 1.3 × 10¹³ |
| 2 | Nitrifying Bacteria | CFU/ml | 1 × 10⁷ | 1.7 × 10¹⁰ |
| 3 | De-Nitrifying Bacteria | CFU/ml | 3.6 × 10⁷ | 5.3 × 10⁹ |

As shown in Table 9, the bacterial count including aerobic, nitrifying and de-nitrifying bacteria is observed to be increased during AGBR reactor operation with walnut media. Increase in de-nitrifying count indicates that layered internal structure of media is proving favorable conditions for anaerobic/anoxic bacteria to reside safely and to maintain growth. The increase in nitrifying bacterial count has reflected in very good reduction of ammonia nitrogen, which was achieved up to 99% during AGBR operation with walnut media.

### Conclusion

The SBR reactor was operated with and without media and investigated the possibility of application of different media in SBR process and its advantages. Overall, we have determined that the following is typically true for embodiments as reported and claimed herein.
1. SBR reactor operation without media worked nicely up to certain exchange volume, in terms of total ammonia nitrogen reduction; however, increase of exchange volume does not sustain the outlet product quality and total nitrogen reduction. Though sludge had good settling property and response to change in process condition, the nitrification and de-nitrification was not effective at high exchange volume. More than 90% ammonia and >75% total nitrogen reduction was observed with 30% exchange volume, dropping in both ammonia and total nitrogen reduction was observed with further increase in exchange volume to 45%.
2. In the trial with PAC media, it was observed that media was showing good development of biological culture over its surface and porous area can be utilized for growth of biological culture. The trial with PAC media showed improvement in product quality over without media. Results showed that ammonia nitrogen reduction was improved to >90% even at 45% exchange volume and total nitrogen reduction increased to >80% till 40% exchange volume. But media was still observed to be having some limitation in holding de-nitrifying culture at 45% exchange volume.
3. In further trial with walnut shell media, much improved product quality and control over process parameters was observed. The layered structure of media provided very good bonding with microbiological culture to reside nitrifying and de-nitrifying bacteria. The bacteriological analysis showed that there was an increase in number of aerobic, nitrifying and de-nitrifying culture during trial with walnut shell media. The ammonia nitrogen reduction was 99% and total nitrogen reduction increased to >90%, product BOD was observed to be <5.0 ppm. The settling property and character of sludge was very good. Sludge can be easily handled and having free flowing property after drying.
4. During AGBR study, process automatization and real time data monitoring played very important roles in optimization of operation and process parameters. The real time data of pH, ORP, DO, ammonia nitrogen and nitrate provided substantial information to draw correlation between various parameters. It also helped to understand process kinetics in different stages of the AGBR process during cyclic operation.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

We claim:

1. A batch reactor process for purification of wastewater, comprising, in a single vessel:
feeding and distributing a wastewater into a microbial sludge bed;
keeping the wastewater in an environment including anaerobic bacteria until reaching a target pH;
increasing an amount of oxygen in the wastewater in an aeration step, and keeping the wastewater in an oxygenated environment including aerobic bacteria;
allowing the microbial sludge bed to settle, thereby separating the microbial sludge bed from a purified wastewater; and
removing a volume of purified wastewater.

2. The process of claim 1, further comprising, after removing the volume of purified wastewater, returning to the step of feeding wastewater through the microbial sludge bed.

3. The process of claim 1, further comprising maintaining the aerobic bacteria, anoxic and anaerobic bacteria in culture on a fluidized bed media.

4. The process of claim 3, wherein the media is selected from the group consisting of walnut shell, powder activated carbon, granular activated carbon, and sand.

5. The process of claim 4, wherein the media is walnut shell.

6. The process of claim 5, wherein the walnut shell media has a particle size between 50 to 500 micron.

7. The process of claim 3, wherein the media is present in the vessel at 2 to 25% of reactor volume.

8. The process of claim 3, wherein the media has a mesh size between 50 to 500.

9. The process of claim 3, wherein said media is floated with the aeration step and homogenized with biological sludge in the settling step.

10. The process of claim 3, wherein the aerobic and anaerobic bacteria are supported on the culture medium.

11. The process of claim 1, further comprising analyzing one or more parameters selected from the group consisting of biological oxygen demand, chemical oxygen demand, dissolved oxygen, nitrogen concentration, and nitrate concentration, and advancing the process to a subsequent step when a threshold value for a parameter is met.

12. The process of claim 11, wherein the analysis is continuous during operation of the batch reactor process.

13. The process of claim 11, wherein the analysis leads to full automation of the batch reactor process.

14. The process of claim 3, wherein more than 90% of carbon and 90% of nitrogen are removed from the wastewater by the purification.

15. The process of claim 1, wherein the purification removes phosphate from the wastewater.

16. An apparatus for conducting the process of claim 1.
